(19) United States
(12) Patent Application Publication
(10) Pub. No.: US 2024/0380607 A1
(43) Pub. Date: Nov. 14, 2024

(54) Systems And Methods For Verification Of Data Erasure

(71) Applicant: Intel Corporation, Santa Clara, CA (US)

(72) Inventors: Tat Kin Tan, Penang (MY); Michael Neve De Mevergnies, Guidel (FR)

(73) Assignee: Intel Corporation, Santa Clara, CA (US)

(21) Appl. No.: 18/196,112

(22) Filed: May 11, 2023

(51) Int. Cl. H04L 9/32; G06F 21/72

(52) U.S. Cl. CPC H04L 9/3247; G06F 21/72; H04L 9/3239

(57) ABSTRACT

An integrated circuit includes a region of configurable logic circuits, and a control circuit that generates a digital signature based on a private key and data using a signing engine for verifying that data stored in the region of the configurable logic circuits has been erased. A method is provided for verifying that the region of the configurable logic circuits in the integrated circuit has been erased. The method includes receiving a public key, data, and a digital signature at a control circuit comprising a signature verifier engine, and generating an output that verifies whether the region of the configurable logic circuits has been erased by performing a signature verification of the digital signature using the data and the public key with the signature verifier engine.

### TECHNICAL FIELD

The present disclosure relates to electronic circuits and systems, and more particularly, to systems, circuits, and methods for verification of data erasure.

### BACKGROUND ART

Configurable integrated circuits can be configured by users to implement desired custom logic functions. In a typical scenario, a logic designer uses computer-aided design tools to design a custom circuit design. When the design process is complete, the computer-aided design tools generate configuration data. The configuration data is then loaded into configuration memory elements that configure configurable logic circuits in the integrated circuit to perform the functions of the custom circuit design. Configurable integrated circuits can be used for co-processing in big-data or fast-data applications. For example, configurable integrated circuits may be used in application acceleration tasks in a datacenter and may be reprogrammed during datacenter operation to perform different tasks.

### BRIEF DESCRIPTION OF DRAWINGS

FIG. 1 is a diagram that illustrates an example of a configurable integrated circuit (IC) that includes regions of configurable logic and regions of static logic.

FIG. 2 is a diagram that illustrates a system and a process for generating a digital signature from data and a private key.

FIG. 3 is a diagram that illustrates a system and a process for verifying a digital signature using a public key and data.

FIG. 4 is a diagram that illustrates a system and a process for generating a digital signature from a hash value and a private key using a trusted wiping attestation service (TWAS).

FIG. 5 is a diagram that illustrates a system and a process for verifying a digital signature with a hash value and a public key using a signature verifier engine (SVE).

FIG. 6 illustrates an example of a configurable integrated circuit (IC) that can include circuits disclosed herein.

### DETAILED DESCRIPTION

In some applications of configurable integrated circuits (ICs), a cloud service provider (CSP) rents out allocations of configurable logic circuits in a single configurable integrated circuit (IC) to multiple customers. Configurable ICs are often designed to allow customers to configure their own circuit designs to process workloads, without the burden of equipment management. A CSP can rent out regions of configurable logic circuits in a configurable IC to multiple customers so that the customers can load their own configuration data for sensitive or proprietary circuit designs into the rented regions of the configurable IC.

Renting out regions of configurable logic in a single configurable IC to multiple customers (i.e., tenants) increase utilization of resources. In order to provide a cost effective solution, the CSP resets the rented regions of configurable logic and allows the same configurable logic regions to be reused by different tenants over time. However, this application creates problems regarding how to provide assurances to the tenants that there is no residual data left after the rental period expires, how to ensure that each tenant's data (and/or sensitive bitstream configurations) is properly erased upon completion, and how to ensure that the next tenant who is renting a region of the configurable IC would not be capable of accessing the previous tenant's data from that region.

Regions of configurable logic circuits in a configurable IC that are rented to tenants can be zeroized (i.e., reset to their initial default value) after termination of the rental periods by reconfiguring the regions using bitstreams. However, previously known systems do not have a mechanism that the CSP can provide to its tenants to prove to the tenants that the regions have been zeroized at the correct locations by the correct person or entity, and at the right time (i.e. before the next tenant is about to rent the region). After a rental period terminates, a tenant may not have the ability to verify that rented regions of configurable logic were erased. Thus, in previously known systems, the tenants have to trust that the CSP has zeroized the rented regions of configurable logic.

According to some examples disclosed herein, systems, circuits, and methods are provided for attesting and verifying that one or more regions of configurable logic circuits in an integrated circuit (IC) have been successfully erased. In these examples, the systems, circuits, and methods can attest that data (e.g., configuration data for configuring configurable logic circuits) stored in the one or more regions of configurable logic circuits in the IC have been deleted. These systems, circuits, and methods can, for example, be used to attest that one or more regions of configurable logic circuits in the IC that have been rented by a tenant (e.g., of a cloud service provider (CSP)) have been properly erased by a verified provider. These systems, circuits, and methods can be used to verify that the one or more regions of the configurable logic circuits rented by one tenant have been erased before another tenant uses the same one or more regions to store additional data. These systems, circuits, and methods can, for example, be used to prevent malicious code or customer sensitive data that is stored in one or more regions of configurable logic circuits during the rental period of one tenant from remaining in these regions of configurable logic circuits during the subsequent rental period of another tenant. The erasure of the region can extend beyond configurable logic, for example, to erasure of reserved memory protected ranges (e.g., in random access memory), key materials (such as bitstream decryption key) stored in memory, keys in general purpose hardware blocks, etc.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

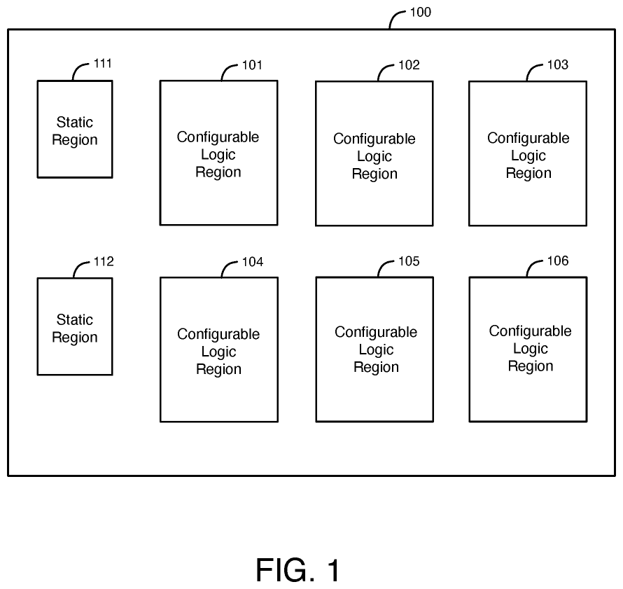

FIG. 1 is a diagram that illustrates an example of a configurable integrated circuit (IC) that includes regions of configurable logic circuits and regions of static logic circuits. In the example of Figure (FIG. 1, configurable IC 100 includes 6 regions 101-106 of configurable logic circuits and 2 regions 111-112 of static logic circuits. Although, ICs implementing the techniques disclosed herein can have any number of regions of configurable and static logic circuits. The regions 111-112 of static logic circuits include logic circuits that are not configurable with configuration data. Each of the regions 101-106 includes configurable logic circuits (e.g., lookup tables, adaptive logic modules, etc.) that are configurable using configuration data. Each of the regions 101-106 of configurable logic circuits can be reconfigured with additional configuration data (e.g., using partial reconfiguration techniques). The regions 101-106 of configurable logic circuits can be different sizes or the same size. Configurable logic circuits are also referred to herein simply as configurable logic.

According to some applications of configurable IC 100, a provider (such as a CSP) can rent one or more of the regions 101-106 of configurable logic to tenants for use in configuring their own circuit designs (e.g., for proprietary services). As examples, tenants can use the regions 101-106 to configure circuit designs for machine learning algorithms, hardware acceleration features, data security, data compression, video processing, etc. The tenants can, for example, rent the regions 101-106 from a provider for defined rental periods of time to configure solutions for their particular applications.

A tenant that rents one or more regions of configurable logic (such as regions 101-106) may want to attest whether a provider has erased configuration data stored in the one or more regions of configurable logic after the rental time period has expired. According to some examples disclosed herein, verification systems and methods are provided that verify whether configuration data has been erased from the correct regions of configurable logic in an IC that were rented by the tenant from a provider. These regions can then be rented out to one or more other tenants. These systems and methods do not exclusively rely on the tenant trusting the provider for erasing the rented regions.

According to some examples disclosed herein, an attestation challenge mechanism is provided for one or more regions of configurable logic in an IC. A tenant that has rented one or more of the regions of configurable logic can use a signature verification engine to attest that the one or more regions have been fully erased by the correct provider after the rental period has ended. In these examples, a signing engine generates a digital signature using data and a private key. The signature verification engine uses the digital signature, the data, and a public key to determine whether the one or more regions of configurable logic have been properly erased (e.g., using data zeroization). The data can, for example, be generated by performing a cryptographic hash algorithm using a nonce value, an identifier for the IC, and an identifier for the one or more regions of configurable logic.

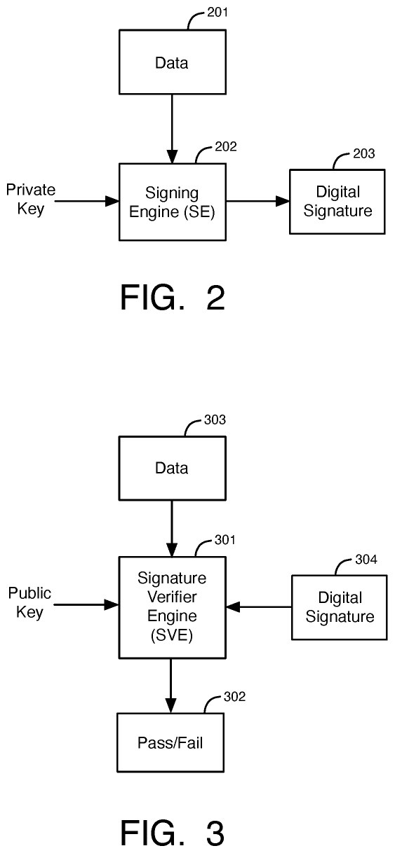

FIG. 2 is a diagram that illustrates a system and a process for generating a digital signature from data and a private key. Initially, a key pair that includes a private key and a public key is generated for the system. The key pair can, for example, be generated and managed by a security controller circuit in a static region of a configurable IC. The private key and the data 201 are provided as inputs to a signing engine (SE) 202. The signing engine 202 generates a digital signature 203 using the private key and the data 201. The signing engine 202 can, for example, implement the Digital Signature Algorithm (DSA) to generate the digital signature 203 using the private key and the data 201. The signing engine 202 includes a control circuit that can be, for example, located in a static or configurable region of the configurable IC.

FIG. 3 is a diagram that illustrates a system and a process for verifying a digital signature using a public key. The system of FIG. 3 includes a signature verifier engine (SVE) 301 that receives 3 inputs, including data 303, a public key, and a digital signature 304. The signature verifier engine (SVE) 301 generates a binary output 302 indicating a pass or fail value that is based on the 3 inputs entered to SVE 301, including data 303, the public key, and digital signature 304. The SVE 301 generates a pass value in output 302 indicating that the digital signature 304 has been correctly verified, if the data 303 is the same as data 201, the public key is from the key pair described above, and the digital signature 304 is the same as digital signature 203. The SVE 301 generates a Fail value in output 302 if any one of data 303, digital signature 304, or the public key input to SVE 301 is not the same as data 201, digital signature 203, or the public key that is part of the public-private key pair that includes the private key, respectively. SVE 301 includes a control circuit that can be, for example, located in a static or configurable region of the configurable IC.

In some implementations, a trusted wiping attestation service (TWAS) can establish a trusted mechanism that is capable of attesting that a region of configurable logic in an IC has been properly erased by a trusted service. In these implementations, the data provided to the signing engine as an input is a hash value. The hash value is generated by performing a hash function using a nonce value, an identifier (ID) for the IC, and an identifier (ID) for the region of configurable logic in the IC.

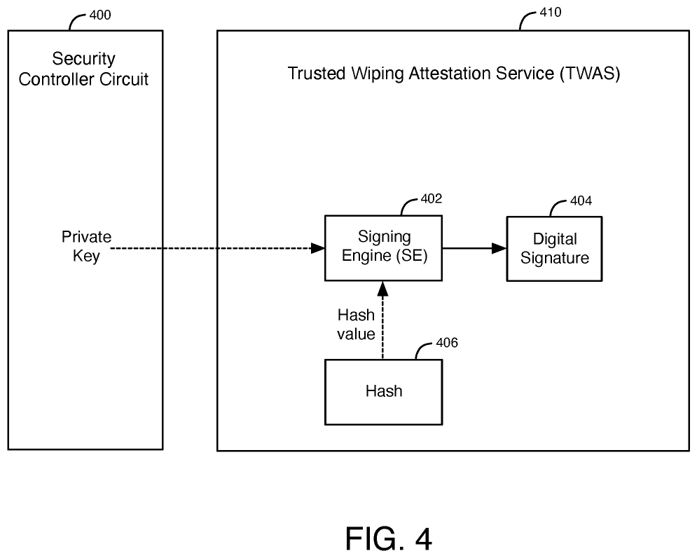

FIG. 4 is a diagram that illustrates a system and a process for generating a digital signature from a hash value and a private key using a trusted wiping attestation service (TWAS) 410. TWAS 410 includes a signing engine 402 in the example of FIG. 4. The TWAS 410 can be in the IC that contains the regions of configurable logic or in another IC or system. The IC (e.g., a configurable IC) containing the regions of configurable logic includes a security controller circuit 400 that generates a key pair including public and private keys and provides the private key to the signing engine 402, as shown in FIG. 4.

The TWAS 410 also includes hash circuitry 406 that is capable of performing a cryptographic hash function. Hash circuity 406 performs the cryptographic hash function by mapping 3 input values to a hash value. More specifically, hash circuity 406 performs the cryptographic hash function by mapping a nonce value, an identifier (ID_IC) for the IC, and an identifier (ID_PR) for a region of configurable logic in the IC to the hash value. The nonce value can be, for example, a value generated by, and/or provided from, a tenant of the region of configurable logic in the IC having identifier ID_PR. The ID (ID_PR) for the region of configurable logic rented by the tenant is unique relative to all of the other regions in the IC. The ID (ID_IC) for the IC is unique relative to any other ICs in a given system. Here a nonce is provided as an example. Another example of an input to the hash circuitry 406 is a universally trusted time reference.

The signing engine 402 generates a digital signature 404 using the private key and the hash value generated by the hash circuitry 406. The signing engine 402 can, for example, implement the Digital Signature Algorithm (DSA) to generate the digital signature 404 using the private key and the hash value. The signing engine 402 includes a control circuit that can be, for example, located in a static or programmable region of the IC.

Before a selected region of configurable logic in the IC is configured with configuration data from a tenant (e.g., configuration data of a tenant's persona), a computer system prompts a user (e.g., the tenant) for the nonce value and then transmits the entered nonce value to the security controller circuit 400. The selected region of the configurable logic is identified by ID_PR, and the IC is identified by ID_IC. The security controller circuit 400 has access to both of these identifiers ID_PR and ID_IC.

In response to receiving the nonce value, the security controller circuit 400 erases all of the data stored in the selected region of configurable logic identified by ID_PR (e.g., the configuration data of a previous tenant). After the selected region of configurable logic (ID_PR) has been erased, the security controller circuit 400 transmits the private key to TWAS 410. The hash circuitry 406 generates a hash value H using the nonce value N (e.g., received from security controller circuit 400), the identifier (ID_IC) for the IC, and the identifier (ID_PR) for the selected region of configurable logic in the IC (i.e., H=hash (N, ID_PR, ID_IC)). The SE 402 then generates the digital signature 404 using the hash value generated by hash circuitry 406 and the corresponding private key from security controller circuit 400. The digital signature 404 is transmitted to the user (e.g., via a CSP).

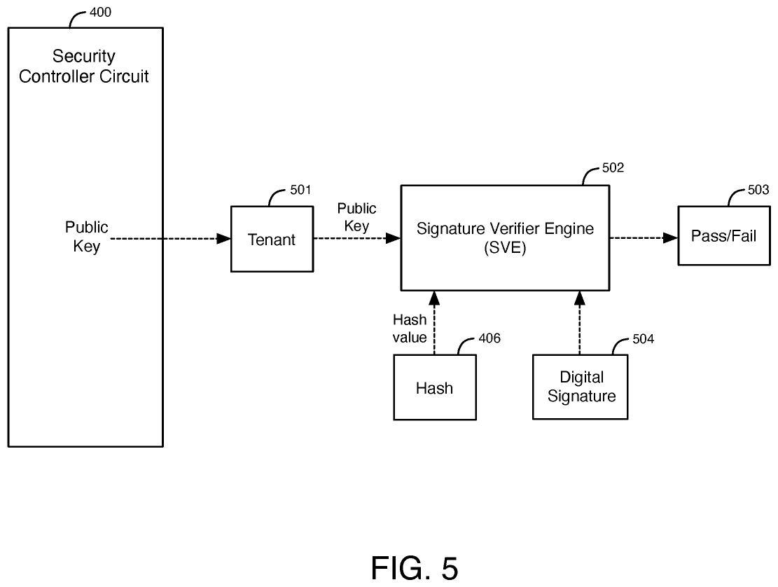

FIG. 5 is a diagram that illustrates a system and a process for verifying a digital signature with a hash value and a public key using a signature verifier engine (SVE) 502. A tenant 501 of a selected region of configurable logic circuits in an IC can use the process and system of FIG. 5 to verify that the selected region of configurable logic circuits has been erased by the security controller circuit 400 under the control of a verified entity (e.g., cloud service provider). The security controller circuit 400 can provide the public key of the key pair to the tenant 501 in response to a request from the tenant 501 to verify that configuration data stored in the selected region of configurable logic circuits in the IC has been erased. The tenant 501 can then provide the public key to the SVE 502. The SVE 502 includes a control circuit that can be, for example, located in a static or configurable region of the IC. The components of FIG. 5 including security controller circuit 400, SVE 502, and hash circuitry 406 can, for example, be implemented in the IC and/or in a computer system having multiple ICs.

The hash circuitry 406 performs the cryptographic hash function by calculating a hash value. For example, hash circuitry 406 can map the identifier (ID_IC) for the IC, the identifier (ID_PR) for the selected region of configurable logic in the IC, and the nonce value to the hash value. The nonce value may be provided to the hash circuitry 406 from the tenant 501. The identifiers ID_PR and ID_IC may be provided to the hash circuitry 406 from the security controller circuit 400. The hash circuitry 406 provides the hash value to the signature verifier engine (SVE) 502. The tenant 501 provides a digital signature 504 to the SVE 502. In order to verify that the selected region of configurable logic in the IC has been erased, the digital signature 504 must be the same as the digital signature 404 generated in the process of FIG. 4.

The SVE 502 generates a binary output 503 indicating a pass or fail value that is based on the 3 inputs entered to SVE 502, including the hash value, the public key, and the digital signature 504. The SVE 502 generating a pass value in output 503 indicates that the digital signature 504 has been correctly verified as the correct digital signature 404 with the corresponding hash value and the public key. A pass value in output 503 indicates that the digital signature 504 was generated using the correct private key, the correct nonce value, the correct identifiers ID_PR and ID_IC, and the digital signature 404. A pass value in output 503 also indicates to the tenant 501 that the security controller circuit 400 has successfully erased the configuration data stored in the selected region of configurable logic (ID_PR) in the IC under the command of the tenant 501, because the hash value used by SVE 502 to generate output 503 was generated by circuitry 406 using the nonce value provided by the tenant 501.

The SVE 502 generates a fail value in output 503 if the digital signature verification process did not pass. The SVE 502 generates a fail value in output 503 if any one of the public key input to SVE 502, the hash value input to SVE 502, or the digital signature 504 is not the same as the correct public key, the correct hash value, or the digital signature 404, respectively. For example, the output 503 indicates a fail value if the digital signature 504 does not match the digital signature 404. The output 503 also indicates a fail value if one of the values used to generate the hash value is incorrect (i.e., the nonce value, ID_PR, or ID_IC). The output 503 also indicates a fail value if the public key provided to SVE 502 is not part of the correct public-private key pair, which indicates that security controller circuit 400 is not verified as performing the erase of the selected region of configurable logic circuits.

According to another example, the hash circuitry 406 can generate the hash value based on 2 nonce values in addition to using the identifier (ID_IC) for the IC and the identifier (ID_PR) for the selected region of configurable logic circuits in the IC. The SE 402 generates the digital signature 404 using the private key and the hash value generated using both nonce values. The 2 nonce values can be, for example, an exit nonce value and an entry nonce value. The exit nonce value is selected by the tenant that is leaving or exiting the region of configurable logic (ID_PR) in the IC in order to prove that the configuration data stored in that region has been properly erased. The entry nonce value is selected by the next tenant that is about to configure the region of configurable logic (ID_PR) with new configuration data in order to prove that prior configurations of that region have been properly erased. This technique enables the security controller circuit 400 to perform a single erase of the region of configurable logic in between tenants and to generate a single digital signature that both tenants can independently verify. This technique also enables shorter delays between configurations of the region of configurable logic.

According to other examples, the tenant can optionally select an erasing mode that the security controller circuit 400 uses to erase data stored in the selected region of configurable logic. The security controller circuit 400 can erase data in the selected region of configurable logic, for example, in a standard erasing mode that is safe for most utilizations, or in another erasing mode that is more secure and that may be required for tenants that store highly-sensitive data in the selected region of configurable logic. In this example, the digital signature 203/404 can include a tag that indicates an erasing mode that is selected by the tenant. This feature can be used to prove to the tenant that the selected erasing mode has been applied to erase data in the selected region of configurable logic.

The attestation system can include a public key chosen by the tenant. When a security engine creates an attestation certificate, the tenant's public key is included in the hash H. The security engine then stores the nonce and the public key, as credential information for the next tenant for the region. In this way, the security engine only accepts a bitstream for this particular region if verified by the tenant's public key and if the bitstream contains the specific nonce. This provides the assurance to the tenant that, since the creation of the wiping attestation certificate, the CSP would not have been able to schedule another tenant before the legitimate tenant (i.e. the one that receives the attestation certificate).

The security system is still able to ‘clear the reservation’, for example, in case the legitimate tenant is not providing the bitstream in the agreed timeline. Via this construction, the legitimate tenant is still assured that its bitstream would be accepted by the security engine if and only if the security engine has wiped the region and has reserved this region to this specific tenant.

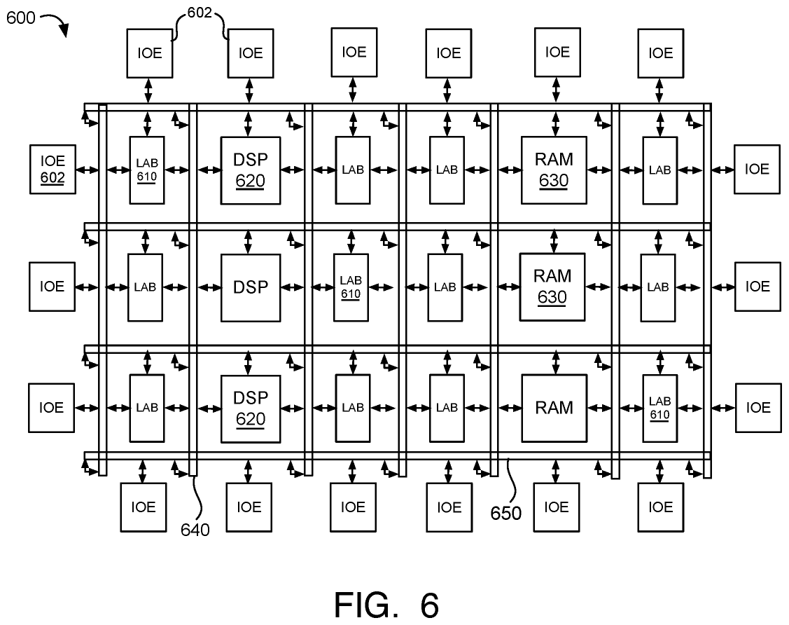

FIG. 6 illustrates an example of a configurable integrated circuit (IC) 600 that can include circuits disclosed herein. For example, the configurable IC 600 can be IC 100 disclosed herein with respect to FIG. 1. As shown in FIG. 6, the configurable integrated circuit (IC) 600 includes a two-dimensional array of configurable (programmable) functional circuit blocks, including configurable logic array blocks (LABs) 610 and other functional circuit blocks, such as random access memory (RAM) blocks 630 and digital signal processing (DSP) blocks 620. Functional blocks such as LABs 610 can include smaller programmable logic circuits (e.g., logic elements, logic blocks, or adaptive logic modules) that receive input signals and perform custom functions on the input signals to produce output signals. In some implementations, LABs 610 can be, or include, the regions of configurable logic of FIG. 1. The configurable functional circuit blocks shown in FIG. 6 can be organized into sectors or can each include multiple sectors of configurable logic circuits.

In addition, configurable IC 600 can have input/output elements (IOEs) 602 for driving signals off of configurable IC 600 and for receiving signals from other devices. Input/output elements 602 can include parallel input/output circuitry, serial data transceiver circuitry, differential receiver and transmitter circuitry, or other circuitry used to connect one integrated circuit to another integrated circuit. As shown, input/output elements 602 can be located around the periphery of the chip. If desired, the configurable IC 600 can have input/output elements 602 arranged in different ways. For example, input/output elements 602 can form one or more columns, rows, or islands of input/output elements that may be located anywhere on the configurable IC 600.

The configurable IC 600 can also include programmable interconnect circuitry in the form of vertical routing channels 640 (i.e., interconnects formed along a vertical axis of configurable IC 600) and horizontal routing channels 650 (i.e., interconnects formed along a horizontal axis of configurable IC 600), each routing channel including at least one conductor to route at least one signal.

Note that other routing topologies, besides the topology of the interconnect circuitry depicted in FIG. 6, may be used. For example, the routing topology can include wires that travel diagonally or that travel horizontally and vertically along different parts of their extent as well as wires that are perpendicular to the device plane in the case of three dimensional integrated circuits. The driver of a wire can be located at a different point than one end of a wire.

Furthermore, it should be understood that embodiments disclosed herein with respect to FIGS. 1-5 can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Configurable IC 600 contains memory elements (e.g., in RAM 630 and/or in memory in LABs 610 or DSPs 620). The memory elements can be loaded with configuration data using input/output elements (IOEs) 602. Once loaded, the memory elements each provide a corresponding static control signal that controls the operation of an associated configurable functional block (e.g., LABs 610, DSP blocks 620, RAM blocks 630, or input/output elements 602).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Configurable logic circuit elements that can be controlled in this way include multiplexers (e.g., multiplexers used for forming routing paths in interconnect circuits), look-up tables, logic arrays, AND, OR, XOR, NAND, and NOR logic gates, pass gates, etc.

The programmable memory elements can be organized in a configuration memory array having rows and columns. A data register that spans across all columns and an address register that spans across all rows can receive configuration data. The configuration data can be shifted onto the data register. When the appropriate address register is asserted, the data register writes the configuration data to the configuration memory bits of the row that was designated by the address register.

In certain embodiments, configurable IC 600 can include configuration memory that is organized in sectors, whereby a sector can include the configuration RAM bits that specify the functions and/or interconnections of the subcomponents and wires in or crossing that sector. Each sector can include separate data and address registers.

The configurable IC 600 of FIG. 6 is merely one example of an IC that can be used with embodiments disclosed herein. The embodiments disclosed herein can be used with any suitable integrated circuit or system. For example, the embodiments disclosed herein can be used with numerous types of devices such as processor integrated circuits, central processing units, memory integrated circuits, graphics processing unit integrated circuits, application specific standard products (ASSPs), application specific integrated circuits (ASICs), and configurable/programmable integrated circuits. Examples of configurable integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now disclosed. Example 1 is a method for verifying that a region of configurable logic circuits in an integrated circuit has been erased, the method comprising: receiving a first key, first data, and a digital signature at a first control circuit comprising a signature verifier engine; and performing a signature verification of the digital signature with the signature verifier engine using the first data and the first key to generate an output that verifies whether the region of the configurable logic circuits in the integrated circuit has been erased.

In Example 2, the method of Example 1 further comprises: generating a hash value with a hash function using hash circuitry, wherein the first data comprises the hash value.

In Example 3, the method of Example 2 may optionally include, wherein generating the hash value comprises generating the hash value using a first nonce value from a first user.

In Example 4, the method of Example 3 may optionally include, wherein generating the hash value further comprises generating the hash value using the first nonce value and a second nonce value from a second user.

In Example 5, the method of any one of Examples 2-4 may optionally include, wherein generating the hash value further comprises generating the hash value using a first identifier that identifies the region of the configurable logic circuits and a second identifier that identifies the integrated circuit.

In Example 6, the method of any one of Examples 1-5 further comprises: generating the digital signature using a signing engine in a second control circuit based on a second key and the first data, wherein the first key and the second key are part of a key pair.

In Example 7, the method of any one of Examples 1-6 further comprises: erasing second data stored in memory in the region of the configurable logic circuits in response to receiving a nonce value from a user using a security controller circuit in the integrated circuit.

In Example 8, the method of any one of Examples 1-7 further comprises: allowing configuration of the region of the configurable logic circuits in response to the digital signature being generated.

Example 9 is an integrated circuit comprising: a region of configurable logic circuits; and a first control circuit that generates a digital signature based on a private key and first data using a signing engine for verifying that second data stored in the region of the configurable logic circuits has been deleted.

In Example 10, the integrated circuit of Example 9 further comprises: hash circuitry that generates a hash value using a hash function, wherein the first data comprises the hash value.

In Example 11, the integrated circuit of Example 10 may optionally include, wherein the hash circuitry generates the hash value using a first nonce value.

In Example 12, the integrated circuit of Example 11 may optionally include, wherein the hash circuitry generates the hash value using a second nonce value.

In Example 13, the integrated circuit of any one of Examples 10-12 may optionally include, wherein the hash circuitry generates the hash value using a first identifier that identifies the region of the configurable logic circuits and a second identifier that identifies the integrated circuit.

In Example 14, the integrated circuit of any one of Examples 9-13 further comprises: a second control circuit comprising a signature verifier engine that generates an output verifying whether the second data stored in the region of the configurable logic circuits has been deleted by performing a signature verification of the digital signature using a public key.

In Example 15, the integrated circuit of any one of Examples 9-14 further comprises: a security controller circuit that deletes the second data stored in the region of the configurable logic circuits in response to receiving an input from a user.

Example 16 is a non-transitory computer readable storage medium comprising instructions stored thereon for causing a computer system to execute a method for verifying that data stored in a region of configurable logic circuits in an integrated circuit has been erased, the method comprising: generating a hash value with hash circuitry using a hash function; and performing a signature verification of a digital signature using the hash value and a first key with a signature verifier engine in a first control circuit to verify if the data stored in the region of the configurable logic circuits has been erased.

In Example 17, the non-transitory computer readable storage medium of Example 16 may optionally include, wherein the method further comprises: generating the digital signature using a signing engine in a second control circuit based on a second key and the hash value, wherein the first key and the second key are part of a key pair.

In Example 18, the non-transitory computer readable storage medium of any one of Examples 16-17 may optionally include, wherein generating the hash value comprises generating the hash value using a nonce value from a user.

In Example 19, the non-transitory computer readable storage medium of any one of Examples 16-18 may optionally include, wherein generating the hash value comprises generating the hash value using a first identifier that identifies the region of the configurable logic circuits and a second identifier that identifies the integrated circuit.

In Example 20, the non-transitory computer readable storage medium of any one of Examples 16-19 further comprises: erasing the data stored in the region of the configurable logic circuits in response to receiving a nonce value using a security controller circuit in the integrated circuit.

The foregoing description of the examples has been presented for the purpose of illustration. The foregoing description is not intended to be exhaustive or to be limiting to the examples disclosed herein. In some instances, features of the examples can be employed without a corresponding use of other features as set forth. Many modifications, substitutions, and variations are possible in light of the above teachings.

1. A method for verifying that a region of configurable logic circuits in an integrated circuit has been erased, the method comprising:
receiving a first key, first data, and a digital signature at a first control circuit comprising a signature verifier engine; and
performing a signature verification of the digital signature with the signature verifier engine using the first data and the first key to generate an output that verifies whether the region of the configurable logic circuits in the integrated circuit has been erased.

2. The method of claim 1 further comprising:
generating a hash value with a hash function using hash circuitry, wherein the first data comprises the hash value.

3. The method of claim 2, wherein generating the hash value comprises generating the hash value using a first nonce value from a first user.

4. The method of claim 3, wherein generating the hash value further comprises generating the hash value using the first nonce value and a second nonce value from a second user.

5. The method of claim 2, wherein generating the hash value further comprises generating the hash value using a first identifier that identifies the region of the configurable logic circuits and a second identifier that identifies the integrated circuit.

6. The method of claim 1 further comprising:
generating the digital signature using a signing engine in a second control circuit based on a second key and the first data, wherein the first key and the second key are part of a key pair.

7. The method of claim 1 further comprising:
erasing second data stored in memory in the region of the configurable logic circuits in response to receiving a nonce value from a user using a security controller circuit in the integrated circuit.

8. The method of claim 1 further comprising:
allowing configuration of the region of the configurable logic circuits in response to the digital signature being generated.

9. An integrated circuit comprising:
a region of configurable logic circuits; and
a first control circuit that generates a digital signature based on a private key and first data using a signing engine for verifying that second data stored in the region of the configurable logic circuits has been deleted.

10. The integrated circuit of claim 9 further comprising:
hash circuitry that generates a hash value using a hash function, wherein the first data comprises the hash value.

11. The integrated circuit of claim 10, wherein the hash circuitry generates the hash value using a first nonce value.

12. The integrated circuit of claim 11, wherein the hash circuitry generates the hash value using a second nonce value.

13. The integrated circuit of claim 10, wherein the hash circuitry generates the hash value using a first identifier that identifies the region of the configurable logic circuits and a second identifier that identifies the integrated circuit.

14. The integrated circuit of claim 9 further comprising:
a second control circuit comprising a signature verifier engine that generates an output verifying whether the second data stored in the region of the configurable logic circuits has been deleted by performing a signature verification of the digital signature using a public key.

15. The integrated circuit of claim 9 further comprising:
a security controller circuit that deletes the second data stored in the region of the configurable logic circuits in response to receiving an input from a user.

16. A non-transitory computer readable storage medium comprising instructions stored thereon for causing a computer system to execute a method for verifying that data stored in a region of configurable logic circuits in an integrated circuit has been erased, the method comprising:
generating a hash value with hash circuitry using a hash function; and
performing a signature verification of a digital signature using the hash value and a first key with a signature verifier engine in a first control circuit to verify if the data stored in the region of the configurable logic circuits has been erased.

17. The non-transitory computer readable storage medium of claim 16, wherein the method further comprises:
generating the digital signature using a signing engine in a second control circuit based on a second key and the hash value, wherein the first key and the second key are part of a key pair.

18. The non-transitory computer readable storage medium of claim 16, wherein generating the hash value comprises generating the hash value using a nonce value from a user.

19. The non-transitory computer readable storage medium of claim 16, wherein generating the hash value comprises generating the hash value using a first identifier that identifies the region of the configurable logic circuits and a second identifier that identifies the integrated circuit.

20. The non-transitory computer readable storage medium of claim 16 further comprising:
erasing the data stored in the region of the configurable logic circuits in response to receiving a nonce value using a security controller circuit in the integrated circuit.
